(19) United States
(12) Patent Application Publication
(10) Pub. No.: US 2025/0386915 A1
(43) Pub. Date: Dec. 25, 2025

(54) SAFETY PROTECTION METHOD AND DEVICE FOR FULLY AUTOMATIC NAIL DECORATING

(71) Applicant: SHANGHAI MEINAIER TECHNOLOGY CO., LTD., Shanghai (CN)

(72) Inventors: Qijun ZHA, Shanghai (CN); Long WANG, Shanghai (CN)

(21) Appl. No.: 19/245,732

(22) Filed: Jun. 23, 2025

Related U.S. Application Data
(63) Continuation of application No. PCT/CN2023/079606, filed on Mar. 3, 2023.

(30) Foreign Application Priority Data
Dec. 29, 2022 (CN) 202211707966.X

(51) Int. Cl. A45D 29/00; B41J 3/407; B41J 3/46; B41J 11/00; B41J 29/13; B41J 29/393

(52) U.S. Cl. CPC A45D 29/00; B41J 3/4073; B41J 3/46; B41J 11/0095; B41J 29/13; B41J 29/393; A45D 2029/005

(57) ABSTRACT

A safety protection method for a fully automatic nail decorating, including: starting an arm detection device for a cabin door and a detection device for a hand slot, to perform a first protection action when a user is detected by either of them; starting a protection device for a printing nozzle, to perform a second protection action when a sensor is contacted with any position of a palm of the user, where the protection device includes the sensor; starting the arm detection device for the cabin door and the detection device for the hand slot, to perform a third protection action when the palm of the user is detected by either of them; and ending a nail decorating process and closing the cabin door, when the palm of the user is not detected by the arm detection device for the cabin door and the detection device for the hand slot.

### CROSS-REFERENCE TO RELATED APPLICATIONS

The present application is a U.S. Continuation of International Application PCT/CN2023/079606 filed on Mar. 3, 2023, which claims the benefit of and priority to Chinese patent application No. 202211707966.X filed with China National Intellectual Property Administration on Dec. 29, 2022, the content of the aforementioned applications is incorporated herein by reference in its entirety.

### TECHNICAL FIELD

The present disclosure relates to the field of nail decorating machine technologies, specifically to a safety protection method and device for a fully automatic nail decorating.

### BACKGROUND

Traditional printing modules are equipped with simple collision detection devices, generally composed of hard materials and springs, aimed at protecting a printing nozzle from being damaged due to collision. Only a certain degree of damage to printing workpieces is typically acceptable in traditional printing industry.

### SUMMARY

To address the aforementioned technical issues, the present disclosure provides a safety protection method and a device for a fully automatic nail decorating.

The safety protection device for the fully automatic nail decorating in a nail decorating machine provided by the present disclosure includes a main control module and a safety protection device. The main control module is configured to manage statuses of safety protection sensors in an entire system, and control various modules to perform protection actions according to different statuses. The safety protection device further includes a sensing device configured to detect statuses of a human body in different positions and under different conditions.

Optionally, the main control module is connected to a cloud via a network to obtain order information and nail decorating styles, and report statuses of the nail decorating machine. The main control module interacts with a user through a touch display screen and a loudspeaker.

Optionally, the main control module further includes an independent safety protection logic judgment module, configured to manage safety protection of the nail decorating machine.

Optionally, the sensing device includes: a computer vision module, configured to detect height information of a palm; a protection device for a printing nozzle, configured to prevent a print carriage from colliding with the palm of a user; an arm detection device for a cabin door, configured to detect whether an arm of the user is inside the cabin door; and a detection device for a hand slot, configured to detect whether the palm of the user is placed in the hand slot.

Optionally, the hand slot is provided with a contact sensor, configured to detect whether the palm of the user is placed in position.

Optionally, the protection device includes a soft contact sensor located at the print carriage.

Optionally, the safety protection device further includes a user interaction module. The user interaction module includes a touch display screen and a loudspeaker, and is configured to interact with the user, the user interaction module further includes the cabin door, a controller, arm detection devices installed on both sides of the cabin door, and an emergency stop button.

The safety protection method provided by the present disclosure is based on the protection device and is applicable to the above safety protection device for the fully automatic nail decorating in the nail decorating machine, so as to enhance the safety level of the nail decorating machine, thereby ensuring the stable operation of the nail decorating machine. The safety protection method specifically includes:
starting an arm detection device for a cabin door and a detection device for a hand slot, to perform a first protection action when a user is detected by either of them; starting a protection device for a printing nozzle, to perform a second protection action when a sensor is contacted with any position of a palm of the user, wherein the protection device includes the sensor; starting the arm detection device for the cabin door and the detection device for the hand slot, to perform a third protection action when the palm of the user is detected by either of them; and ending a nail decorating process and closing the cabin door, when the palm of the user is not detected by either of the arm detection device for the cabin door or the detection device for the hand slot.

Optionally, the protection device further includes an emergency stop button. When the emergency stop button is pressed by the user at any time, the first protection action, the second protection action, and the third protection action are immediately performed, and a reset action is not allowed to be manually performed through a touch display screen until no body part of the user is detected in any position inside the nail decorating machine.

Optionally, the sensor includes a soft contacting thin sheet.

Technical Effects and Advantages of the Invention are as follows.

The present disclosure is equipped with two independent protection devices to prevent the failure of protection in case one protection device malfunctions. Not only the human body but also the nail decorating machine are protected from damage.

In the present disclosure, through the first protection action, the second protection action, the third protection action, actions of the nail decorating machine can be suspended by detecting and determining the statuses of the palm, thereby protecting the human body.

### BRIEF DESCRIPTION OF THE DRAWINGS

FIG. 1 is a flowchart of the nail decorating method provided in embodiments of the present disclosure.

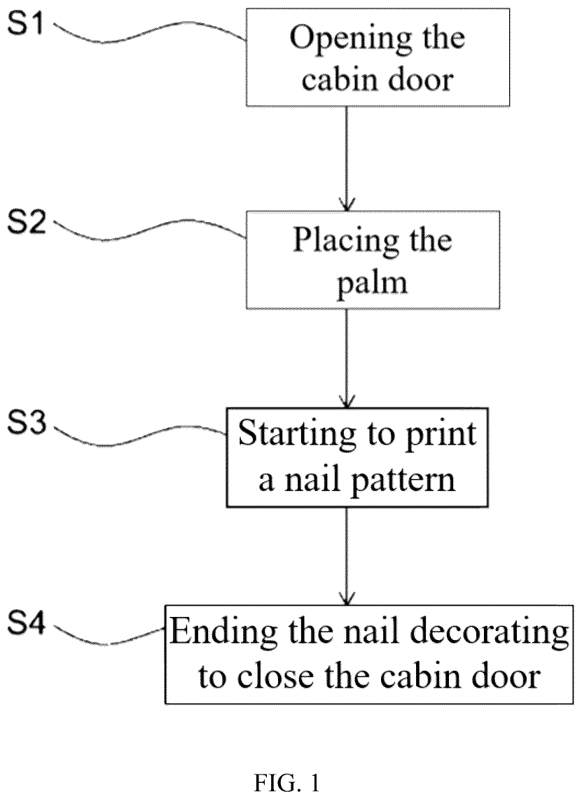

### DETAILED DESCRIPTION

The following is a detailed description of the present disclosure in combination with the drawings and specific implementation modes. The embodiments of the present disclosure are provided for illustrative and descriptive purposes and are not exhaustive or limited to the forms disclosed. Many modifications and variations are obvious to those of ordinary skill in the art. The selection and description of embodiments are to better illustrate the principles and practical applications of the present disclosure, and to enable those of ordinary skill in the art to understand the present disclosure and design various embodiments with various modifications for specific purposes.

Traditional printing modules are equipped with simple collision detection devices, generally composed of hard materials and springs, aimed at protecting a printing nozzle from being damaged due to collision. Only a certain degree of damage to printing workpieces is typically acceptable in traditional printing industry.

The operation object of the nail decorating machine is the human body, so that higher safety protection requirements relative to the general machinery are needed. In a traditional method for nail printing, statuses of a nail decorating machine may be confirmed based on the information interaction between the nail decorating machine and a cloud server, thereby reducing the cost of use and facilitating large-scale application. However, such safety protection on the nail decorating machine cannot protect the user. The nail decorating machine must meet the requirements that the human body should not be harmed, and at least two independent protection devices are required to prevent the failure of protection in case one protection device malfunctions.

To overcome the defects of traditional nail decorating machines, embodiments of the present disclosure provide a safety protection device for a fully automatic nail decorating machine, including a main control module. The main control module is configured to manage the statuses of the safety protection sensors in an entire system (for example, the fully automatic nail decorating machine) and control various modules to perform protective actions according to different statuses.

The main control module is connected to the cloud via a network to obtain order information and nail decorating styles and report the statuses of the nail decorating machine.

The main control module interacts with the user through a touch display screen and a loudspeaker. After determining the start of the nail decorating operations, a hand slot mechanism is controlled to reset first, then a cabin door is opened, and the user is notified to place the palm after the cabin door is fully opened. A computer vision module is called to analyze the finger posture after detecting that the palm is placed, a hand slot is activated to adjust the finger posture after the analysis is completed, and a verification is performed after the adjustment is completed. A nail segmentation is performed after the verification is successful, and image processing is performed after the nail segmentation is completed. Nail decorating operation data is generated after the image processing is completed, and the nail decorating operation data is sent to a printing mechanism by the main control module. After the printing mechanism completes the operation, the above processes are repeated so as to complete all of the nail decorating operations of both hands. After the nail decorating operations are completed, all execution mechanisms are controlled to perform a resetting operation, and a disinfection mechanism is controlled to perform a disinfection operation at the same time. After the disinfection operation is completed, the nail decorating machine enters a standby state.

The main control module further includes an independent safety protection logic judgment module, configured to manage the safety protection operation of the nail decorating machine. The operation object of the nail decorating machine is the human body, so that higher safety protection requirements relative to the general machinery are needed. A safety protection module of the nail decorating machine includes a collision detection device based on computer vision, soft contacting touch protection devices located on both sides of the printing nozzle, an arm detection device located on the cabin door, a palm detection device located in the hand slot, and a manually controlled emergency stop button, so as to form multiple safety protections. The main control module needs to obtain the information of the above devices or sensors in real time to perform safety logic judgments, and protective actions are performed immediately when there is a contact risk or a contact has occurred.

The safety protection device further includes a sensing device to detect the statuses of the human body in different positions and under different conditions. The sensing device includes a computer vision module configured to detect the height information of the palm; a protection device for the printing nozzle configured to prevent the print carriage from colliding with the palm of the user, where the protection device for the printing nozzle includes a soft contacting sensor located on the print carriage; an arm detection device for the cabin door configured to detect whether the arm of the user is inside the cabin; and a hand slot detection device configured to detect whether the palm of the user is placed in the hand slot.

The hand slot mechanism is configured to fix and adjust the fingers of the user. According to the needs of nail decorating, the hand slot is arranged to have two palm placement postures. In the first palm placement posture, four fingers are positioned upward and the thumb is positioned sideways; In the second palm placement posture, the thumb is positioned upward and the four fingers are positioned sideways. The finger positioned upward is the operation object of the nail decorating.

Inside of finger slots for four fingers is provided with an inflatable airbags to fix and protrude the fingers upward. Each finger slot is provided with a motor that can independently rotate leftward and rightward and a control module, so as to adjust the tilted finger so that the front of the nail faces upward. Each finger slot is provided with a motor and a control module that can adjust the height of the finger, so as to adjust the four fingers to the same height.

Inside of a thumb slot is provided with an inflatable airbag to fix and protrude the thumb upward. The thumb slot is provided with a motor that can independently rotate leftward and rightward and a control module, so as to adjust the tilted thumb so that the front of the nail faces upward.

The hand slots are provided with contacting sensors to detect whether the palm of the user is placed in position.

All hand slots are provided with independent pressure sensors to ensure that the comfort level is maintained while fixing the fingers of the user, thereby preventing fingers of the user from compression injury.

In addition, the present disclosure further includes a user interaction module, which includes a touch display screen and a loudspeaker, configured to interact with the user. The user interaction module further includes the cabin door and a controller, arm detection devices installed on both sides of the cabin door, and an emergency stop button. The cabin door is used for the user to place the palm to be nailed, and one or two cabin doors may be arranged according to requirements. The user interacts with the machine through the touch display screen to issue nail decorating instructions. When the nail decorating starts, the cabin door is opened and the arm detection device is activated. If an arm is detected to be approaching during the moving process of the cabin door, all mechanical actions are immediately stopped, and a voice broadcast is made through the loudspeaker to protect the safety of the user. The emergency stop button may be pressed at any time, and protective actions are performed when the button is pressed, that is, the movements of all movable mechanisms inside the nail decorating machine are stopped and the palm of the user is released immediately to ensure the safety of the user.

The safety protection device further includes an emergency braking module, which is the emergency stop button. The emergency stop button has the highest priority in the entire system and can cause the nail decorating machine to immediately perform safety protection actions.

In some other embodiments, a sensor film is provided below the printer. The sensor film is a metal film or a metal sheet having a relatively high detection accuracy.

Embodiments of the present disclosure further provide a safety protection method for a fully automatic nail decorating machine, which is applicable to a nail decorating process for the user of the above safety protection device for the fully automatic nail decorating in the nail decorating machine. The specific steps of the nail decorating process include:
In step S1, opening the cabin door;
In step S2, placing the palm;
In step S3, starting to print a nail pattern; and
In step S4, ending the nail decorating to close the cabin door.

In step S1, the nail decorating machine starts to operate. Optionally, during a stage when the cabin door is opened, if an arm of the user is detected, a third protection action is performed. The user is informed through the user interaction module that the arm should not be approached when the cabin door is moving so as to prevent injury. After detecting that the arm of the user has moved away, the nail decorating machine continues to operate.

In step S2, during the palm placing stage, the arm detection device for the cabin door and the detection device for the hand slot start to operate, and a first protection action is performed if either of them detects the user.

Optionally, before step S3, the computer vision module starts to operate, so as to determine whether there is a collision risk by calculating the highest point of the palm of the user in the nail decorating operation area through a 3D point cloud, and execute step S3 if there is no collision risk.

In step S3, during the nail printing stage, the protection device of the printing nozzle starts to operate. The sensor of the protection device of the printing nozzle includes a soft contacting thin sheet. A second protection action is performed as soon as the sensor is contacted with any position of the palm of the user.

In step S4, after the printing is completed, the arm detection device for the cabin door and the detection device for the hand slot start to operate. A third protection action is performed if the palm of the user is detected by either of them. When the palm of the user is not detected by both of them, step S4 is continued to be performed, that is, the nail decorating is ended, and the cabin door is closed.

Throughout the nail decorating process of the user, when the emergency stop button is pressed by the user at any time, the first protection action, the second protection action, and the third protection action are immediately performed, and a reset action is not allowed to be manually performed through a touch display screen until no body part of the user is detected in any position inside the nail decorating machine.

The third protection action is to stop the movement of the cabin door, that is, to stop the movement of the cabin door immediately regardless of whether an opening command, a closing command, an action to stop the hand slot, or an action to stop the printer is performed.

The first protection action is to refuse to perform the printer maintenance action, including: returning to the origin, flash spraying, cleaning the printing nozzle, and refusing to perform the hand slot rotation action or refusing to perform the cabin door action.

The second protection action is to stop the movement of the print carriage, release the palm of the user, and notify the user to remove the palm out through the user interaction module.

The schematic example of the nail decorating machine may refer to the nail decorating machine described and illustrated in the international application PCT/CN2023/079604 of the same applicant. To avoid obscuring the inventive concept of the present disclosure, it is not described here again.

Obviously, the described embodiments are only a part of the embodiments of the present disclosure, not all of them. Based on the embodiments of the present disclosure, all other embodiments obtained by those of ordinary skill in the art without making creative efforts should be within the scope of protection of the present disclosure. Structures, devices, and operating methods not specifically described and explained in the present disclosure are implemented according to the conventional means of the art.

What is claimed is:

1. A safety protection device for a fully automatic nail decorating in a nail decorating machine, comprising a main control module and a safety protection device;
wherein the main control module is configured to manage statuses of safety protection sensors in an entire system, and control various modules to perform protection actions according to different statuses;
the safety protection device further comprises a sensing device configured to detect statuses of a human body in different positions and under different conditions.

2. The safety protection device for the fully automatic nail decorating in the nail decorating machine according to claim 1, wherein the main control module is connected to a cloud via a network to obtain order information and nail decorating styles, and report statuses of the nail decorating machine.

3. The safety protection device for the fully automatic nail decorating in the nail decorating machine according to claim 2, wherein the main control module further comprises an independent safety protection logic judgment module, configured to manage safety protection of the nail decorating machine.

4. The safety protection device for the fully automatic nail decorating in the nail decorating machine according to claim 3, wherein the sensing device comprises:
a computer vision module, configured to detect height information of a palm;
a protection device for a printing nozzle, configured to prevent a print carriage from colliding with the palm of a user;
an arm detection device for a cabin door, configured to detect whether an arm of the user is inside the cabin door; and
a detection device for a hand slot, configured to detect whether the palm of the user is placed in the hand slot.

5. The safety protection device for the fully automatic nail decorating in the nail decorating machine according to claim 4, wherein the hand slot is provided with a contact sensor, configured to detect whether the palm of the user is placed in position.

6. The safety protection device for the fully automatic nail decorating in the nail decorating machine according to claim 5, wherein the protection device comprises a soft contact sensor located at the print carriage.

7. The safety protection device for the fully automatic nail decorating in the nail decorating machine according to claim 6, further comprising a user interaction module, wherein the user interaction module comprises a touch display screen and a loudspeaker, and is configured to interact with the user, the user interaction module further comprises the cabin door, a controller, arm detection devices installed on both sides of the cabin door, and an emergency stop button.

8. A safety protection method for a fully automatic nail decorating, applicable to the safety protection device for the fully automatic nail decorating in the nail decorating machine according to claim 1, comprising:
starting an arm detection device for a cabin door and a detection device for a hand slot, to perform a first protection action when a user is detected by either of them;
starting a protection device for a printing nozzle, to perform a second protection action when a sensor is contacted with any position of a palm of the user, wherein the protection device comprises the sensor;
starting the arm detection device for the cabin door and the detection device for the hand slot, to perform a third protection action when the palm of the user is detected by either of them; and
ending a nail decorating process and closing the cabin door, when the palm of the user is not detected by either of the arm detection device for the cabin door or the detection device for the hand slot.

9. The safety protection method for the fully automatic nail decorating according to claim 8, wherein the protection device further comprises an emergency stop button, wherein when the emergency stop button is pressed by the user at any time, the first protection action, the second protection action, and the third protection action are immediately performed, and a reset action is not allowed to be manually performed through a touch display screen until no body part of the user is detected in any position inside the nail decorating machine.

10. The safety protection method for the fully automatic nail decorating according to claim 9, wherein the sensor comprises a soft contacting thin sheet.
